(19) United States
(12) Patent Application Publication
(10) Pub. No.: US 2016/0075105 A1
(43) Pub. Date: Mar. 17, 2016

(54) AUTOMOTIVE VEHICLE EXTERIOR LAMINATE COMPONENT AND METHOD OF FORMING SAME

(71) Applicant: BASF Coatings GmbH, Muenster (DE)

(72) Inventors: Paul E. Lamberty, Romeo, MI (US); Matthijs Groenewolt, Muenster (DE); Henan Li, Muenster (DE)

(21) Appl. No.: 14/488,972

(22) Filed: Sep. 17, 2014

(51) Int. Cl. B32B 7/12; B32B 27/06; B32B 15/20; B32B 15/18; B32B 37/18; B32B 27/40; B32B 27/36; B32B 27/34; B32B 27/30; B32B 38/00; B32B 15/08; B32B 27/38

(52) U.S. Cl. CPC B32B 7/12; B32B 15/08; B32B 27/06; B32B 15/20; B32B 15/18; B32B 27/38; B32B 27/40; B32B 27/36; B32B 27/34; B32B 27/306; B32B 38/0012; B32B 37/182; B32B 2250/02; B32B 2255/06; B32B 2262/10; B32B 2262/101; B32B 2262/02; B32B 2262/0261; B32B 2605/08

(57) ABSTRACT

An automotive vehicle exterior laminate component includes an outer metal layer having a thickness of from about 100 micrometers to about 400 micrometers. The outer metal layer has a first major side having a Class A surface and a second major side spaced opposite the first major side. The automotive vehicle exterior laminate component also includes a structural layer formed from a fiber-reinforced thermoset composition and disposed adjacent to the second major side. A method of forming the automotive vehicle exterior laminate component is also disclosed.

### TECHNICAL FIELD

The disclosure relates to an automotive vehicle exterior laminate component and to a method of forming the automotive vehicle exterior laminate component.

### BACKGROUND

Reinforced composites offer strong, lightweight alternatives to steel and other metals for automotive vehicle exterior components. Such reinforced composites often include a plurality of reinforcing fibers dispersed throughout a cured resin. As such, the reinforced composites also often include broken or protruding fibers and/or define pores or depressions between adjacent fibers. The broken or protruding fibers and/or pores or depressions may contribute to surface irregularities when the surface is coated.

### SUMMARY

An automotive vehicle exterior laminate component includes an outer metal layer having a thickness of from about 100 micrometers to about 400 micrometers. The outer metal layer has a first major side having a Class A surface and a second major side spaced opposite the first major side. The automotive vehicle exterior laminate component also includes a structural layer formed from a fiber-reinforced thermoset composition and disposed adjacent to the second major side.

A method of forming an automotive vehicle exterior laminate component includes stamping a metal sheet to form an outer metal layer. The outer metal layer has a thickness of from about 100 micrometers to about 400 micrometers. The outer metal layer also has a first major side having a Class A surface and a second major side spaced opposite the first major side. The method further includes arranging the outer metal layer in a cavity defined by a mold having a wall so that the first major side faces the wall. After arranging, the method includes disposing one or more layers formed from a fiber-reinforced thermoset composition adjacent to the second major side. In addition, the method includes curing the fiber-reinforced thermoset composition in the cavity to form a structural layer adjacent to the outer metal layer and thereby form the automotive vehicle exterior laminate component.

A method of forming an automotive vehicle exterior laminate component includes providing an outer metal layer having a thickness of from about 100 micrometers to about 400 micrometers. The outer metal layer has a first major side having a Class A surface and a second major side spaced opposite the first major side. The method also includes providing a molded composite component having a mating surface. The method further includes sandwiching an adhesive layer between the second major side and the mating surface, and bonding together the second major side and the mating surface to form the automotive vehicle exterior laminate component.

An automotive vehicle exterior laminate component is disclosed. For example, the automotive vehicle exterior laminate component may be a body panel, a hood, or a deck lid, and includes a laminate having an outer metal layer formed from, for example, aluminum, steel, or magnesium that has a thickness of from about 100 micrometers to about 400 micrometers. The laminate also includes an adjacent structural layer formed from a fiber-reinforced thermoset composition. The outer metal layer is relatively thin, i.e., comparatively thinner than the structural layer, and is not a structural component of the laminate. That is, the outer metal layer does not provide the automotive vehicle exterior laminate component with structural rigidity. Although the outer metal layer may increase the ultimate tensile strength of the laminate as measured by the ASTM D3039 test method as compared to a component which does not include the outer metal layer, the increased ultimate tensile strength is merely a secondary effect or benefit such that the outer metal layer is not characterized as a structural or supporting element of the automotive vehicle exterior laminate component. The automotive exterior vehicle laminate component may also include a coating layer disposed on the second major side, an adhesive layer disposed on the second major side, or an adhesive layer disposed on the coating layer that is disposed on the second major side.

Reinforcing fibers in the structural layer may be selected from, for example, carbon fibers, graphite fibers, glass fibers, boron fibers, silicon carbide fibers, poly(benzothiazole) fibers, poly(benzimidazole) fibers, poly(benzoxazole) fibers, alumina fibers, titania fibers, and aromatic polyamide fibers. The fiber-reinforced thermoset composition may be, for example, an epoxy composition, a polyester composition, a phenolic composition, a polyamide composition, a polyamide-imide composition, a polyurethane composition, or a vinyl ester composition.

The automotive vehicle exterior laminate component is made by stamping the outer metal layer from a metal sheet formed from, for example, aluminum, steel, or magnesium. The outer metal layer has a thickness of from about 100 micrometers to about 400 micrometers and has the first major side having the Class A surface. The terminology “Class A surface” refers to a surface that is of high quality, is smooth and substantially free from deficiencies or irregularities, and is an external surface that is visible to an observer positioned adjacent to a vehicle. After stamping, the outer metal layer is arranged in a mold defining a cavity and having a wall so that the first major side having the Class A surface faces the wall. One or more layers formed from a fiber-reinforced thermoset composition are disposed adjacent to the second major side. The one or more layers may be pre-impregnated composite layers comprising a fiber reinforcement and a partially-cured resin composition; fiber reinforcement layers impregnated with an uncured resin composition; or some combination of these. The partially-cured resin composition or uncured resin composition is cured in the cavity to form the structural layer adjacent to the outer metal layer and thereby form the automotive vehicle exterior laminate component having the Class A surface. Again, the outer metal layer does not form a structural component or element of the automotive vehicle exterior laminate component.

In various embodiments, the metal sheet from which the outer metal layer is stamped may have a second major side opposite the Class A surface. In various embodiments, a coating layer formed from a thermoset polymeric coating composition may be disposed on the second major side. Alternatively, an adhesive layer instead of the coating layer may be disposed on the second major side. For example, a hot melt adhesive may be disposed between the outer metal layer and the one or more layers formed from the fiber-reinforced thermoset composition. As another alternative, the adhesive layer may be disposed on the coating layer which is disposed on the opposite, second major side.

In another example, the stamped outer metal layer may be bonded with an adhesive to an already-molded composite component by pressing the outer metal layer and the already-molded composite component together, optionally with heating, to bond the outer metal layer to the already-molded composite component. The bonding may take place in the cavity defined by the mold. As before, the outer metal layer has a thickness of from about 100 micrometers to about 400 micrometers, a Class A surface, and the opposite second major side that faces the already-molded composite component. An adhesive is placed between the outer metal layer and the already-molded composite component. In one example, the outer metal layer has the adhesive layer applied to the second major side. The adhesive layer may be a hot melt adhesive and may be placed between the outer metal layer and the already-molded composite component.

The Class A surface of the outer metal layer can be finished with one or more paint layers. For example, the automotive vehicle exterior laminate component may be used to assemble an automotive vehicle body, e.g., a “body-in-white”, which may then be finished with a cured film formed from an electrocoat coating composition, a primer coating composition, and/or a topcoat coating composition. The disclosed automotive vehicle exterior laminate component has the Class A surface and facilitates Class A automotive original equipment manufacturer finishes. The outer metal layer also helps minimize buckling of the structural layer, e.g., buckling of underlying fiber mats, during molding and curing. When included in a vehicle body prior to treatment of the vehicle body with an electrocoat coating composition, the outer metal layer is receptive to an even, smooth cured film formed from the electrocoat coating composition.

Without the outer metal layer, surface irregularities such as inconsistent fiber weaves, protruding broken fibers, and/or pores defined between the fibers may telegraph or show through a cured coating composition disposed on the structural layer to form visible finish or coating irregularities that often must be carefully refinished. Moreover, when such components, i.e., components which do not include the outer metal layer, are included in a vehicle body that is coated in an electrocoat painting process, surfaces of the components are often coated roughly and unevenly. This compounds the problems of irregular and rough surfaces for subsequent finishing layers of topcoat colorcoat and clearcoat coatings. In addition, where a fiber-reinforced component that does not include the outer metal layer, for example a hood, is disposed adjacent to a sheet metal component, for example a fender, a mismatch of the painted appearance may occur.

In this description, “a,” “an,” “the,” “at least one,” and “one or more” are used interchangeably to indicate that at least one of the item is present. A plurality of such items may be present unless the context clearly indicates otherwise. All numerical values of parameters (e.g., of quantities or conditions) are to be understood as being modified in all instances by the term “about” whether or not “about” actually appears before the numerical value. “About” indicates that the stated numerical value allows some slight imprecision (i.e., with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments. The terms “comprises,” “comprising,” “includes,” “including,” “has,” and “having,” are inclusive and therefore specify the presence of stated items, but do not preclude the presence of other items. The term “or” includes each of the listed items individually and any and all combinations of two or more of the listed items. Thus, “a, b, or c” is a disclosure of a alone, b alone, c alone, both a and b, both a and c, both b and c, and all of a, b, and c.

### BRIEF DESCRIPTION OF THE DRAWINGS

FIG. 1 is a schematic illustration of a perspective, partial view of an automotive vehicle including an automotive vehicle exterior laminate component;

FIG. 2 is a schematic illustration of a cross-sectional view of the automotive vehicle exterior laminate component of FIG. 1 taken along section lines 2-2;

FIG. 3 is a flowchart of a method of forming the automotive vehicle exterior laminate component of FIG. 1;

FIG. 4 is a flowchart of another embodiment of the method of FIG. 3;

FIG. 5 is a schematic illustration of an exploded perspective view of a portion of the method of FIG. 3; and

FIG. 6 is a schematic illustration of a cross-sectional view of another embodiment of the portion of the method of FIG. 3.

### DETAILED DESCRIPTION

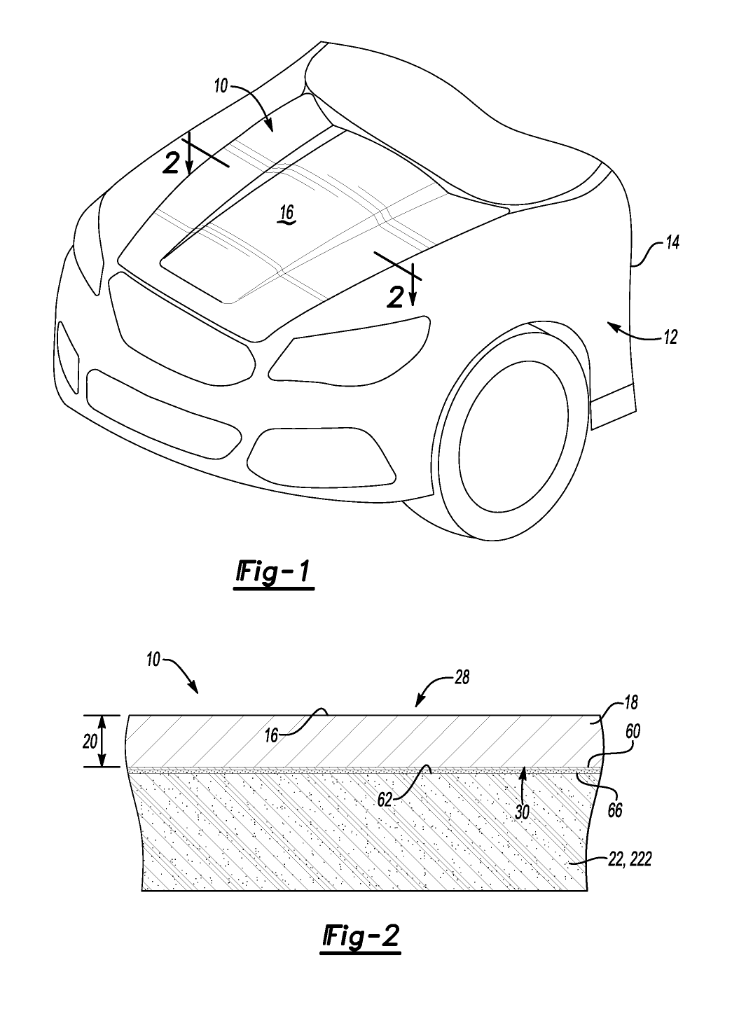

Referring to the Figures, wherein like reference numerals refer to like elements, an automotive vehicle exterior laminate component 10 is shown generally in FIG. 1. The automotive vehicle exterior laminate component 10 may be characterized as a laminate and may be suitable for forming an exterior portion 12 of an automotive vehicle 14. That is, in contrast to an interior component (not shown) of the automotive vehicle 14, such as a frame or support, which is not visible to an observer of the automotive vehicle 14, the automotive vehicle exterior laminate component 10 may form the exterior portion 12 of the automotive vehicle 14 and be visible to an observer situated adjacent to the automotive vehicle 14. The automotive vehicle 14 may be, for example, a passenger sedan, a truck, and/or a sport utility vehicle, and the automotive vehicle exterior laminate component 10 may be used as a vehicle body panel, such as a door panel, a side panel, a deck lid, a hood, and a fender.

As set forth in more detail below, the automotive vehicle exterior laminate component 10 provides a Class A surface 16 for the automotive vehicle 14. As used herein, the terminology “Class A” refers to a surface which is viewable by the observer during ordinary use of the automotive vehicle 14. Therefore, as compared to components suitable for forming an interior surface of the automotive vehicle 14, a component having a “Class A” surface 16 or finish generally has a comparatively higher gloss and distinctness of image than a non-Class A surface. As such, “Class A” surfaces 16 generally face an observer of the automotive vehicle 14 who is positioned external to the automotive vehicle 14.

Referring now to FIG. 2, the automotive vehicle exterior laminate component 10 includes an outer metal layer 18 having a thickness 20 of from about 100 micrometers to about 400 micrometers and a structural layer 22 formed from a fiber-reinforced thermoset composition. More specifically, the outer metal layer 18 may be laminated or attached to the structural layer 22 to form a metal-composite laminate, i.e., the automotive vehicle exterior laminate component 10, as set forth in more detail below. That is, the outer metal layer 18 forms an outer or exterior layer of the automotive vehicle exterior laminate component 10.

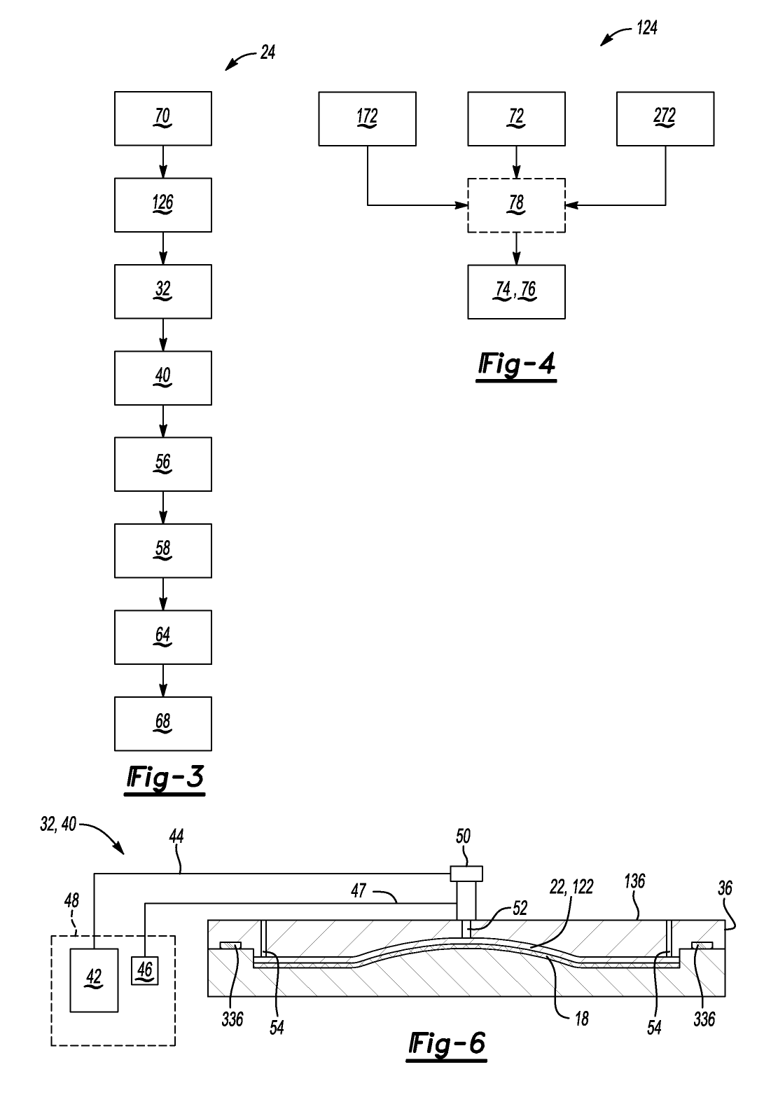

Referring now to FIG. 3, a method 24 of forming the automotive vehicle exterior laminate component 10 includes stamping 126 a metal sheet to form the outer metal layer 18. That is, the outer metal layer 18 may be formed by stamping 126 a thin sheet of metal to form a metal part, i.e., the outer metal layer 18, that has a desired shape corresponding to a shape or contour of the finished automotive vehicle exterior laminate component 10. The automotive vehicle exterior laminate component 10 may have any shape, e.g., a concave shape or a convex shape.

More specifically, stamping 126 of the metal sheet to provide or form the outer metal layer 18 may be carried out by cutting the metal sheet under pressure with stamping equipment. The stamped outer metal layer 18 may have a shape of an automotive body panel, a hood, a roof, a decklid, a door panel, a rocker panel, a fender, or another desired shape for the finished automotive vehicle exterior laminate component 10. For example, referring to FIG. 1, the automotive vehicle exterior laminate component 10 may be an automotive vehicle hood.

The metal sheet and the outer metal layer 18 may be formed from a material selected from the group consisting of aluminum, steel, and magnesium and may have a first major side 28 (FIG. 2) and a second major side 30 (FIG. 2) spaced opposite from the first major side 28. The resulting outer metal layer 18 stamped from the metal sheet does not form a structural or supporting element of the automotive vehicle exterior laminate component 10, but is sufficiently thick to maintain an initial shape during manufacturing of the automotive vehicle exterior laminate component 10 and to prevent telegraphing of irregularities present in the underlying structural layer 22. For example, the metal sheet from which the outer metal layer 18 is stamped may have the thickness 20 of from about 100 micrometers to about 400 micrometers. That is, the thickness 20 may be about 150 micrometers or about 200 micrometers or about 250 micrometers or about 300 micrometers or about 350 micrometers. In various embodiments, the thickness 20 may be from about 200 micrometers to about 300 micrometers or may be from about 250 micrometers to about 350 micrometers.

Referring again to FIG. 2, the outer metal layer 18 stamped from the metal sheet has the first major side 28 having the Class A surface 16 and the second major side 30 spaced opposite the first major side 28. That is, the first major side 28 and the second major side 30 may be two opposite sides 28, 30 of the outer metal layer 18. However, the first major side 28 and the Class A surface 16 may be visible to an observer of the automotive vehicle 14 (FIG. 1) disposed external to the automotive vehicle 14. For example, the first major side 28 having the Class A surface 16 may be finished by painting and coating materials and techniques when the automotive vehicle exterior laminate component 10 is assembled to a body of the automotive vehicle 14. Conversely, the second major side 30 may not be visible to the observer, but may rather face away from the observer towards an interior of the automotive vehicle 14.

Further, the outer metal layer 18 or the metal sheet, e.g., formed from aluminum, may have a treatment or a coating composition applied on one or both major sides 28, 30, i.e. on one or both of the first major side 28 and the second major side 30. For example, a chromate or phosphate conversion coating, related rinses, or other anticorrosion treatment may be applied to one or both of the major sides 28, 30. Such treatments are described in, for example, U.S. Pat. Nos.8,394,459; 6,530,999; 6,241,830; 5,969,019; 5,904,785; 5,888,315; 5,855,695; and 5,795,407, each of which is incorporated herein by reference.

In particular, the method 24 may include applying 70 (FIG. 3) the coating composition to the first major side 28 or Class A surface 16. Suitable coating compositions include electrocoat coating compositions, primer coating compositions, basecoat coating compositions, topcoat coating compositions, topcoat coating compositions, and combinations thereof. In general, such treatments and coatings compositions may be applied by any suitable process, for example, by dip coating, electrocoating, spraying, brushing, and the like.

The coating composition and/or adhesive should be selected to withstand high temperatures, e.g., a temperature of from about 160° C. to about 190° C., during subsequent portions of the method 24 to effect curing of the electrocoat coating composition. Suitable, nonlimiting examples of coating compositions include polyesters, plastisols, polyurethanes, polyvinylidene fluorides (PVDF), epoxies, and primers. The treatment or coating composition may be applied to the metal sheet in a coil coating process. The coil coating process and composition used may be any suitable coil coating process and composition, for example as described in U.S. Pat. Nos. 8,420,174; 8,367,743; 7,071,267; 6,997,980; 6,897,265; 6,541,535; 5,141,818; and 5,084,304, each of which is incorporated herein by reference.

Referring now to FIG. 5, the method 24 (FIG. 3) also includes arranging 32 the outer metal layer 18 in a cavity 34 defined by a mold 36 having a wall 38 so that the first major side 28 faces the wall 38. The stamped shape of the outer metal layer 18 may be selected to fit within the cavity 34 of the mold 36 so that the Class A surface 16 faces the wall 38 of the mold 36.

After arranging 32, the method 24 includes disposing 40 (FIG. 3) one or more layers 122 formed from a fiber-reinforced thermoset composition adjacent to the second major side 30. The fiber-reinforced thermoset composition may comprise a resin and a plurality of fibers dispersed within the resin. The resin may be selected from the group consisting of epoxy resins, polyurethane resins, polyester resins, phenolic resins, polyamide resins, polyamide-imide resins, and vinyl ester resins. Therefore, the fiber-reinforced thermoset composition may be selected from the group consisting of epoxy compositions, polyurethane compositions, polyester compositions, phenolic compositions, polyamide compositions, polyamide-imide compositions, and vinyl ester compositions.

The plurality of fibers may reinforce the resin and may be selected from the group consisting of carbon fibers, graphite fibers, glass fibers such as E-glass fibers or S-glass fibers, boron fibers, silicon carbide fibers, poly(benzothiazole) fibers, poly(benzimidazole) fibers, poly(benzoxazole) fibers, alumina fibers, titania fibers, and aromatic polyamide (aramid) fibers. These may also be used in combination. The plurality of fibers may be characterized by type as short, long, continuous, or woven. Generally, the structural layer 22 may include long fiber reinforcement. For example, long fibers having, on average, a length of greater than about 1 centimeter and a length-to-diameter ratio of greater than about 20 to 1 may be dispersed within the resin. In addition, the plurality of fibers may have the form of a woven cloth or a mat.

An orientation of the plurality of fibers in the one or more layers 122 can be random, such as for a mat, or the orientation can be unidirectional or biaxial, such as for the woven cloth or fabric. For embodiments employing the mat, the plurality of fibers may be woven, knit, needled, braided, and/or chopped. For embodiments in which the plurality fibers are chopped, the plurality of fibers may be aligned in the mat in a predominantly unidirectional manner, transversely oriented, or randomly disposed. The resulting mat may be a felt, and may be stitched, woven, knitted, or otherwise assembled into a two- or three-dimensional arrangement of the plurality of fibers.

For embodiments employing the woven cloth, the plurality of fibers, such as carbon fibers, may first be organized into tows of continuous or near-continuous untwisted fibers that are loosely gathered together. The tows may adopt a ribbon-like configuration, may be generally elliptical in cross-section, and may be optionally lightly secured using an epoxy sizing. Such tows may then be woven into any desired two-dimensional pattern to form the woven cloth, i.e., a reinforcing fabric or sheet. While individual ones of the plurality of fibers may have a diameter of at least about 1 micrometer, each individual fiber may more typically have a diameter of from about 10 micrometers to about 20 micrometers. Further, a typical weave pattern of the woven cloth may be somewhat coarse such that adjacent parallel tows are spaced apart from one another by from about 1 millimeter to about 5 millimeters. The plurality of fibers in a tow may be generally flattened, and may have a cross-sectional dimension of, for example, from about 1 millimeter to about 10 millimeters by from about 0.1 millimeter to about 0.3 millimeters. The tows may be arranged as warp and weft and woven together into the woven cloth.

In one non-limiting example, the one or more layers 122 may be a pre-impregnated composite layer. The pre-impregnated composite layer may comprise a partially-cured resin composition and the plurality of fibers dispersed within the partially-cured resin composition. In another non-limiting example, the one or more layer 122 may be a fiber reinforcement layer, and the fiber reinforcement layer may be impregnated with an uncured resin composition.

That is, the one or more layers 122, for example formed from fiber and in the form of mats or woven cloth, may optionally be pre-impregnated with a partially-cured thermoset resin composition prior to being laid up or molded over the outer metal layer 18. If not pre-impregnated, the one or more fiber layers 122 may be subsequently impregnated with an uncured thermoset resin composition after being laid up over the outer metal layer 18. Further, a combinations of unimpregnated and pre-impregnated layers 122 may be used.

Both the partially-cured thermoset resin composition and the uncured thermoset resin composition may be selected from epoxy compositions, polyurethane compositions, polyester compositions, phenolic compositions, e.g., including phenol formaldehyde resins, polyamide compositions, polyamide-imide compositions, and vinyl ester compositions, e.g., including vinyl ester polyesters. Such materials can be fully cured by crosslinking at temperatures ranging from room temperature to about 300° C., e.g., from about 35° C. or about 80° C. or about 100° C. or about 150° C. to about 200° C. or about 300° C. Various crosslinking mechanisms may be used. For example, the partially-cured thermoset resin composition and/or the uncured thermoset resin composition may include a crosslinking agent, and optionally may further including a catalyst. In another example, the partially-cured thermoset resin composition and/or the uncured thermoset resin composition may be fully cured through application of actinic radiation to ethylenically unsaturated, addition-polymerizable resins.

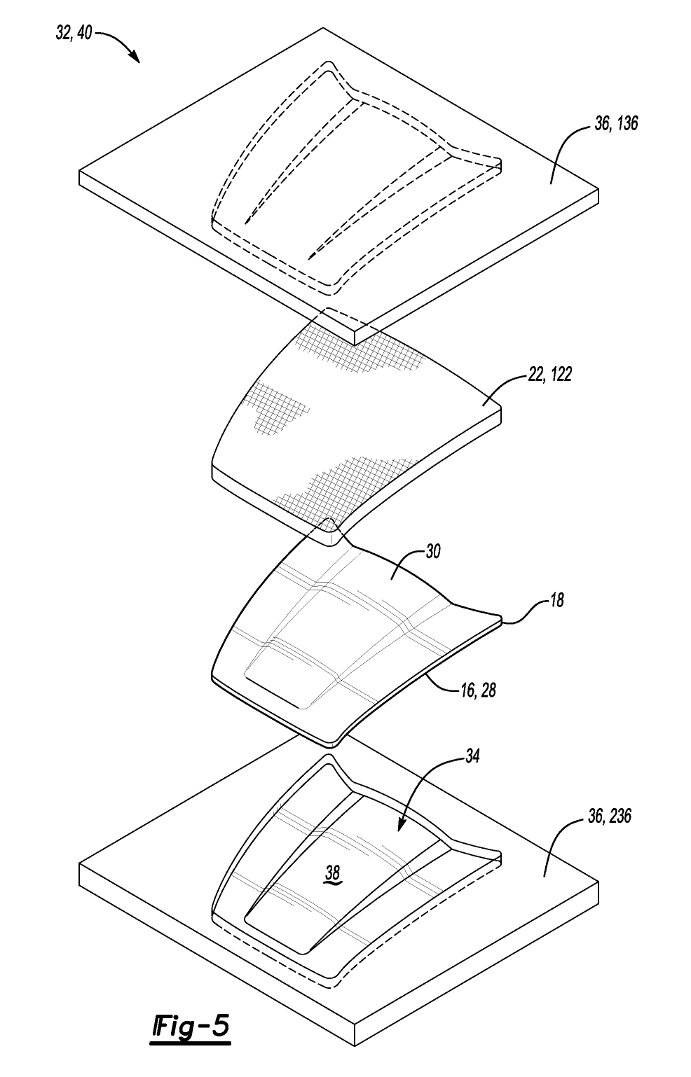

One process for impregnating the one or more layers 122 with the uncured thermoset resin composition is a resin transfer process. As described with reference to FIG. 6, the mold 36 may include a top mold half 136 and a bottom mold half 236 closeable to the top mold half 136 to define the cavity 34 (FIG. 5) therebetween. That is, the top mold half 136 may be placed over the bottom mold half 236, and a gasket 336 may form a seal around a periphery of the mold 36 where the mold halves 136, 236 meet or join. For the resin transfer process, the one or more layers 122 may be laid up in the bottom mold half 236 over the outer metal layer 18. Then, the uncured thermoset resin composition may be pumped from a resin reservoir 42 through a resin line 44 as a catalyst from a catalyst reservoir 46 is pumped through a catalyst line 47 by pump 48 to be mixed together in mixing head 50. The mixture may then be pumped into the cavity 34 through injection port 52. The uncured thermoset resin composition may fill spaces or gaps defined between the plurality of fibers within the one or more layers 122 and may displace air through vent ports 54 defined by the top mold half 136.

In another process for impregnating the one or more layers 122 with the uncured thermoset resin composition, the outer metal layer 18 may be placed in the cavity 34 before the one or more layers 122 are placed in the cavity 34. The one or more layers 122 may be laid over the second major side 30, i.e., an inward-facing side, of the outer metal layer 18. The uncured thermoset resin composition may be applied to each layer 122, for example by spraying or brushing the uncured thermoset resin composition onto the one or more layers 122, and then pressing the uncured thermoset resin composition into the one or more layer 122 with a roller. Additional layers 122 may be added to build up a desired thickness of a layup structure and the eventual structural layer 22. The layup structure may be squeezed together under a light force in order to force the uncured thermoset resin composition and the plurality of fibers into intimate contact.

In another example, the one or more layers 122 may be pre-impregnated with the partially-cured thermoset resin composition, which, for ease of handling, may be partially-cured or B-staged but may remain flexible and conformable. Such a partially-cured thermoset resin composition-impregnated sheet is called a prepreg. The plurality of fibers may be pre-impregnated, for example, by solution dip, spray, or pultrusion. The prepreg may be formed as a thin sheet of unidirectional or woven fibers, and may be cut and laid up in the one or more layers 122 within the cavity 34 of the mold 36. The prepreg may then be assembled adjacent to additional prepregs within the cavity 34 to form the layup structure. In one non-limiting example, the prepreg may be a carbon fiber mat pre-impregnated with a partially-cured thermoset epoxy resin composition. The partially-cured thermoset epoxy resin composition may be formulated to cure at, for example, from about 120° C. to about 180° C. to develop strength. The partially-cured thermoset resin composition may generally be partially cured so that the pregreg has some tack.

The prepregs may be manufactured in unidirectional, woven, or non-woven forms by coating the plurality of fibers or fabric with a partially-cured polymer matrix resin. The partially-cured polymer matrix resin may be selected to intimately bond to a surface of the plurality of fibers. One exemplary partially-cured polymer matrix resin is a bisphenol A-based epoxy resin, which may be partially-cured or B-staged so that the partially-cured polymer matrix resin and a cross-linking agent react only to the extent of producing a viscoelastic solid. The resulting B-staged layers 122 may then be arranged as a stack of prepregs to form the layup structure.

The prepregs may be cut and laid into the cavity 34 by hand. The prepregs may be laid up to form the one or more layers 122 in the cavity 34. More specifically, the prepregs may be laid up such that each additional layer 122 is placed so that the plurality of fibers within each additional layer 122 are disposed at a right angle (or at another angle) to the plurality of fibers of an adjacent layer 122. The plurality of fibers may be braided into strands so that the plurality of fibers extend predominantly along one direction, but are braided or woven together to provide an angle between strands, i.e., the “braid angle”, of from about 15° to about 45°. A fabric-type structure in which the plurality of fibers are interconnected by cross-strands intersecting at about 90° may also be employed.

As a non-limiting example described with reference to FIG. 5, the one or more layers 122 may be laid within the cavity 34 to completely or substantially completely cover the outer metal layer 18 or stamped metal part. Alternatively, in another embodiment, the one or more layers 122 may be laid up, i.e., placed into the cavity 34, first such that the one or more layers 122 face the wall 38 of the mold 36. The outer metal layer 18 may then subsequently be placed over the one or more layers 122 before closing the mold 36.

Regardless of the order of stacking or arranging 32, advantageously, the outer metal layer 18 may permit a comparatively high degree of tolerance or variation for laying up the one or more layers 122. More specifically, during layup, i.e., arranging 32 and disposing 40, small gaps may be defined between adjacent fibers, or the one or more layers 122 may overlap. Such gaps or overlap may not affect an integrity of the structural layer 22 but may generally appear as surface imperfections if the structural layer 22 is coated. However, since the outer metal layer 18 is disposed adjacent to the structural layer 22, i.e., laminated to the structural layer 22, any such gaps or overlaps are covered or smoothed over by the outer metal layer 18 so that the gaps or overlaps do not appear as surface imperfections of the automotive vehicle exterior laminate component 10 when the Class A surface 16 is finished, e.g., painted or coated, with a cured film formed from a coating composition. That is, the outer metal layer 18 presents a smooth, defect-free exterior Class A surface 16 prepared for finishing, i.e., coating.

Referring again to the method 24 as described with reference to FIG. 5, the method 24 also includes curing 56 (FIG. 3) the fiber-reinforced thermoset composition, e.g., the partially-cured resin composition including the plurality of fibers or the uncured resin composition including the plurality of fibers, in the cavity 34 to form the structural layer 22 adjacent to the outer metal layer 18 and thereby form the automotive vehicle exterior laminate component 10. For example, the mold 36 may be heated and closed to cover the cavity 34 so that the partially-cured resin composition or the uncured resin composition is crosslinked or cured and the automotive vehicle exterior laminate component 10 is molded. That is, the resulting layup structure of the one or more layers 122 may be shaped by application of pressure into a desired form and cured by application of heat to produce the desired structural layer 22.

More specifically, for curing 56, the automotive vehicle exterior laminate component 10 may be molded with heat and pressure to cure the partially-cured resin composition or the uncured resin composition and bond the outer metal layer 18 (e.g., aluminum) and the structural layer 22 formed from the one or more layers 122 together. In one example, the layup structure may be cured in an autoclave using a vacuum bag to form the automotive vehicle exterior laminate component 10. The layup structure may be overlaid with an air-impermeable flexible sheet formed from, for example, silicone. The air-impermeable sheet may then be sealed to a substrate surface to form a vacuum bag. A vacuum may be pulled within the vacuum bag upon the sealed assembly in order to evacuate any air from the layup structure. The sealed assembly may be placed in an autoclave, heated, and pressurized to cure the partially-cured resin composition or the uncured resin composition. The laminate may be heated to a temperature above a melting point (or a softening point if there is no melting point) of the partially-cured resin composition or the uncured resin composition. Suction may be applied between the air-impermeable sheet and the substrate surface to urge the air-impermeable sheet toward the substrate surface, vent any generated gases, and by compression, effect good wet out of the plurality of fibers with the resin. Typical cure temperatures may be from about 35° C. to about 300° C., for example from about 80° C. to about 200° C.

Following curing 56, the automotive vehicle exterior laminate component 10, e.g., a carbon fiber hood outer panel, may be removed or demolded or unmolded from the cavity 34 of the mold 36, and the edges may be trimmed with a knife blade or router. That is, the method 24 may also include demolding 58 (FIG. 3) the automotive vehicle exterior laminate component 10 from the cavity 34.

The method 24 may further including applying 64 (FIG. 3) a coating layer 60 to the outer metal layer 18, e.g., to the second major side 30. That is, referring again to FIG. 2, the automotive vehicle exterior laminate component 10 may further include the coating layer 60 disposed on the second major side 30. For example, the structural layer 22 may have a mating surface 62 from which the plurality of fibers may protrude. The coating layer 60 may further insulate the outer metal layer 18 from contact with the plurality of fibers that may lie on or protrude from the mating surface 62 to minimize galvanic corrosion.

The method 24 may further include applying 68 an adhesive layer 66 to the coating layer 60. Alternatively, the method 24 may include applying 68 the adhesive layer 66 directly to the outer metal layer 18. That is, as described with continued reference to FIG. 2, the adhesive layer 66 may be disposed on the second major side 30 or on the coating layer 60.

Therefore, the outer metal layer 18 may have the coating layer 60, the adhesive layer 66, or both disposed on the second major side 30. The coating layer 60 and/or the adhesive layer 66 may prevent or slow galvanic corrosion that may occur due to contact of the outer metal layer 18 with fibers protruding from mating surface 62 of the structural layer 22. The adhesive layer 66 may be applied to the second major side 30 after the outer metal layer 18 or stamped aluminum part has been placed in the mold 36. For example, a layer of a hot melt adhesive may be placed on top of the outer metal layer 18 before the one or more layers 122 are laid over the outer metal layer 18.

Adhesives that may be used to form the adhesive layer 66 may include structural adhesives and non-structural adhesives, for example, polyurethane adhesives, acrylic adhesives, epoxy adhesives, and cyanoacrylate adhesives. If appropriate, for example for adhesives that are stable at ambient temperatures and cure with heat, the adhesive may be applied by a coil coating process. When the adhesive layer 66 is disposed between the outer metal layer 18 and the structural layer 22, the adhesive layer 66 may also cure during curing 56 (FIG. 3).

Alternatively, the adhesive layer 66 may be applied after stamping 126 the metal sheet to form the outer metal layer 18 but before the outer metal layer 18 is disposed in the cavity 34, for example by brushing or spraying an adhesive composition onto the second major side 30. In another alternative, the method 24 may include inserting a sheet formed from a hot melt adhesive composition between the outer metal layer 18 and the one or more layers 122 while arranging 32 and disposing 40.

Referring now to FIG. 4, in one embodiment, the method 124 includes providing 72 the outer metal layer 18 and providing 172 the structural layer 22. As set forth above, providing 72 the outer metal layer 18 may include stamping 126 the metal sheet to form the outer metal layer 18. Providing 172 the structural layer 22 may include disposing 40 the one or more layers 122 formed from the fiber-reinforced thermoset composition adjacent to the second major side 30. That is, the structural layer 22 is formed from the fiber-reinforced thermoset composition and is disposed adjacent to the second major side 30.

The method 124 also includes providing 272 a molded composite component 222 having the mating surface 62 (FIG. 2). That is, the mating surface 62 may face the second major side 30 and may provide an interface between the outer metal layer 18 and the molded composite component 222. The molded composite component 222 may be pre-molded into an already-formed part before attaching the outer metal layer 18 to the molded composite component 222. For example, the molded composite component 222 may be a composite structural inner panel (not shown) of the automotive vehicle 14. The composite structural inner panel may be formed from, for example, a compression-molded sheet-molding (SMC) or carbon composite. Therefore, the automotive vehicle exterior laminate component 10 may be bonded as an outer skin panel onto the molded composite component 222. For example, the automotive vehicle exterior laminate component 10 may be bonded to a supporting member or members in a vacuum fixture using a room-temperature, two-part polyurethane structural adhesive.

The method 124 also includes bonding 74 together the second major side 30 and the mating surface 62, for example, in the cavity 34 of the mold 36 to form the automotive vehicle exterior laminate component 10. As such, bonding 74 may include smoothing 76 the mating surface 62 by covering the mating surface 62 with the outer metal layer 18 so that any inconsistent fiber weaves, broken or protruding fibers, and/or pores or depressions defined between adjacent fibers are minimized. Therefore, the outer metal layer 18 may provide the Class A surface 16 that is suitable for receiving the coating composition, e.g., an electrocoat coating composition, while the structural layer 22 provides rigidity, structure, and/or strength to the automotive vehicle exterior laminate component 10.

More specifically, the method 124 also includes sandwiching 78 the adhesive layer 66 between the second major side 30 and the mating surface 62. For example, sandwiching 78 may include pressing the molded composite component 222 and the outer metal layer 18 against the adhesive layer 66, optionally with heating, to bond the outer metal layer 18 to the molded composite component 222. Therefore, bonding 74 may include curing the adhesive layer 66.

Without the outer metal layer 18, surfaces of other automotive vehicle exterior components (not shown) formed from fiber-reinforced resin compositions may suffer from inconsistent mat weaves, broken or protruding fibers, incompletely or unevenly coated fibers, mat buckling, mat overlap, gaps defined between mats, porous regions defined between fibers, and other irregularities caused by outgassing during molding or finishing operations. The outer metal layer 18, i.e., a thin metal or aluminum veneer, of the automotive vehicle exterior laminate component 10 formed by the disclosed method 24, 124 minimizes such visible surface irregularities. Further, because the outer metal layer 18 is only thick enough to cover and not telegraph any surface irregularities of the structural layer 22, and is not used as a structural component of the automotive vehicle exterior laminate component 10, the outer metal layer 18 adds minimal weight to the automotive vehicle exterior laminate component 10 and to the automotive vehicle 14 (FIG. 1).

While the best modes for carrying out the disclosure have been described in detail, those familiar with the art to which this disclosure relates will recognize various alternative designs and embodiments for practicing the disclosure within the scope of the appended claims.

1. An automotive vehicle exterior laminate component comprising:
an outer metal layer having a thickness of from about 100 micrometers to about 400 micrometers, wherein the outer metal layer has a first major side having a Class A surface and a second major side spaced opposite the first major side; and
a structural layer formed from a fiber-reinforced thermoset composition and disposed adjacent to the second major side.

2. The automotive vehicle exterior laminate component of claim 1, further including a coating layer disposed on the second major side.

3. The automotive vehicle exterior laminate component of claim 1, further including an adhesive layer disposed on the second major side.

4. The automotive vehicle exterior laminate component of claim 1, further including a coating layer disposed on the second major side, and an adhesive layer disposed on the coating layer.

5. The automotive vehicle exterior laminate component of claim 1, wherein the outer metal layer is formed from a material selected from the group consisting of aluminum, steel, and magnesium.

6. The automotive vehicle exterior laminate component of claim 1, wherein the fiber-reinforced thermoset composition comprises a resin and a plurality of fibers dispersed within the resin.

7. The automotive vehicle exterior laminate component of claim 6, wherein the plurality of fibers is selected from the group consisting of carbon fibers, graphite fibers, glass fibers, boron fibers, silicon carbide fibers, poly(benzothiazole) fibers, poly(benzimidazole) fibers, poly(benzoxazole) fibers, alumina fibers, titania fibers, and aromatic polyamide fibers.

8. The automotive vehicle exterior laminate component of claim 7, wherein the fiber-reinforced thermoset composition is selected from the group consisting of epoxy compositions, polyurethane compositions, polyester compositions, phenolic compositions, polyamide compositions, polyamide-imide compositions, and vinyl ester compositions.

9. A method of forming an automotive vehicle exterior laminate component, the method comprising:
stamping a metal sheet to form an outer metal layer;
wherein the outer metal layer has a thickness of from about 100 micrometers to about 400 micrometers;
wherein the outer metal layer has a first major side having a Class A surface and a second major side spaced opposite the first major side;
arranging the outer metal layer in a cavity defined by a mold having a wall so that the first major side faces the wall;
after arranging, disposing one or more layers formed from a fiber-reinforced thermoset composition adjacent to the second major side; and
curing the fiber-reinforced thermoset composition in the cavity to form a structural layer adjacent to the outer metal layer and thereby form the automotive vehicle exterior laminate component.

10. The method of claim 9, further including demolding the automotive vehicle exterior laminate component from the cavity.

11. The method of claim 9, further including applying a coating layer to the second major side.

12. The method of claim 11, further including applying an adhesive layer to the coating layer.

13. The method of claim 9, wherein disposing includes inserting a sheet formed from a hot melt adhesive composition between the outer metal layer and the one or more layers formed from the fiber-reinforced thermoset composition.

14. The method of claim 9, further including applying a coating composition to the first major side.

15. A method of forming an automotive vehicle exterior laminate component, the method comprising:
providing an outer metal layer having a thickness of from about 100 micrometers to about 400 micrometers;
wherein the outer metal layer has a first major side having a Class A surface and a second major side spaced opposite the first major side;
providing a molded composite component having a mating surface;
sandwiching an adhesive layer between the second major side and the mating surface; and
bonding together the second major side and the mating surface to form the automotive vehicle exterior laminate component.

16. The method of claim 15, wherein providing the outer metal layer includes stamping a metal sheet to form the outer metal layer.

17. The method of claim 15, wherein sandwiching includes pressing the molded composite component and the outer metal layer against the adhesive layer.

18. The method of claim 17, wherein bonding includes curing the adhesive layer.

19. The method of claim 15, wherein bonding includes smoothing the mating surface.

20. The method of claim 15, further including applying a coating composition to the Class A surface.
